(19) United States
(12) Patent Application Publication
(10) Pub. No.: US 2005/0125797 A1
(43) Pub. Date: Jun. 9, 2005

(54) Resource management for a system-on-chip (SoC)

(75) Inventors: Maria Gabrani, Gattikon (CH); Andreas C. Doering, Adliswil (CH); Patricia M. Saqmeister, Adliswil (CH); Peter Buchmann, Wald (CH); Andreas Herkersdorf, Inning am Ammersee (DE)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 11/005,955

(22) Filed: Dec. 7, 2004

(30) Foreign Application Priority Data
Dec. 9, 2003 (EP) 03405881.8

(51) Int. Cl. G06F 9/46

(52) U.S. Cl. 718/100

(57) ABSTRACT

Provides evaluation and management of system resources in a data processing system, particularly in a SoC device and for optimizing the operation of the system wherein the system having a plurality of components each operable to process dedicated tasks in the data processing system, wherein each of the components has its associated current resource usages depending on the currently processed task and/or its future resource usage depending on the tasks to be processed next, wherein the resource usage indicates the type of resources and the amount of resources used, wherein the processing of the task of at least one of the components can be modified to adapt the resource usage of this or other component. A method including: determining operating states; estimating current and future resource usage; if necessary adapting task processing according to a predefined scheme to reduce the-resource usage.

### FIELD OF THE INVENTION

The present invention is directed to providing methods for autonomously evaluating and managing system resources in a system-on-chip device. The present invention further relates to a data processing system for autonomously evaluating and managing system resources in a system-on-chip environment.

### BACKGROUND OF THE INVENTION

Resource monitoring and management in different forms has been used mainly in computer and information/data processing systems. The resources being under control in these systems are typically instruction and/or IO processors, memories and IO devices, such as terminals, work stations, printers, microphones and the like. The main goal in most approaches is to monitor the resource usage and when shortage is identified, to notify the appropriate control point, such as the computer operator or administrator in order to initiate the appropriate system upgrade. Accordingly, reference is made to the documents Berg, W. F., Dietel, J. D. and Rowlance, E. J., “Object-Oriented I/O device Interface Framework Mechanism”, IBM Corporation, U.S. Pat. No. 6,449,660, Sep. 10, 2002 and Sipple, R. E., Kunz, B. T. and Hansen, L. B., “Apparatus and method of automatic monitoring of computer performance”, Unisys Corporation, U.S. Pat. No. 6,405,327 B1, Jun. 11, 2002. The data collection and diagnostics analysis is distributed in the system's components triggered in a periodic way while the processing of the information and the appropriate decision-making is central. The approach in the latter document, moreover, creates color coded messages addressed to the computer operator to indicate the state of the resources.

Monitoring and management of hardware-shared resources are also known in information processing systems. This is shown in document EP 218 871 B1.

In document Chase, J. S., et al., “Managing Energy and Server Resources in Hosting Centers”, ACM Symposium on Operating Systems Principles, Chateau Lake Louise, Calif., Oct. 21-24, 2001, a monitoring and management of hardware-shared resources is shown in a real-time operating system, e.g. for hosting servers.

In these cases, typically two or more requesters (i.e. programs, tasks, services) compete for the same components and then based on some policy function (typically priority-based) the resources of these components are allocated in a timely fashion. The managed components can be ports or channels, telephone lines, telephones, speakers, microphones and instruction memory partitions as well as edge servers, application servers, databases and storage.

In all of the above approaches, the components providing the resources are external devices with well-defined interfaces. In a system-on-chip (SoC) architecture where the components are embedded on a single chip new challenges appear; the cost and complexity of the mechanisms to both evaluate and manage the resources are more critical, the required response time has to be faster and the granularity of events upon which activations need to be initiated has to be increased.

In a system-on-chip components can e.g. comprise one or more ports wherein the ports are used to exchange data with corresponding ports of other components. A common port is frequently used where the component uses the port to exchange data with a system component, such as a memory.

Current trends demand for different levels of integration, use and service creation along with dynamic service deployment. This is particularly eminent in the networks domains and in services such as Grid computing, Peer-to-Peer (P2P) and web services, among others. Service and application-providers need this for increasing their portfolio of available services and to be able to accommodate different demands from customers and different capabilities from the network infrastructure and customers seeking custom-based services able to adapt to their quality demands and billing capabilities. Different levels of service integration and use can be facilitated through the programmability of network, storage and computation resources. Dynamic deployment and instantiation of services require resource control functions that allow sharing and avoid conflict of resources. In addition, the increased complexity and cost of the system administration and control demand the design of autonomous systems that adjust to various circumstances and prepare their resources to handle their work loads more efficiently. On the other hand, power consumption, performance and complex application-driven demands lead to application-specific hardware solutions.

In order to cope with the flexibility-given by the programmability and the high demands systems are provided that incorporate both programmable and dedicated functional components. In the network domain, such systems are network processors which further, for performance and modularity reasons, are designed based on a system on chip architecture.

Furthermore, as components are individually designed, arbitration is used for the access of a common resource and buffers are used at the port to generate some elasticity in the access. Thus, the transfers from the components and on the port do not have to take place at the same time. However, such buffers may be costly, increasing the higher speed over the port and with a longer time horizon of the temporal decoupling in the number of associated components.

### SUMMARY OF THE INVENTION

Therefore, it is an object of the present invention to provide a method and a data processing system to control and adjust the diverse system resources in order to support an autonomous fashion of task processing.

According to a first aspect of the present invention, a method is provided for evaluating and managing the system resources in a data processing system, particularly in a SoC device. The system has a plurality of components on-chip, each operable to process dedicated tasks in this data processing system. Each of the components uses one or more resources upon execution of an associated task. The term “resource usage” thus defines in this context the type of resource and the amount of resource a component makes use of upon execution of a dedicated task, wherein a component can make use of one or more resources when processing a task. The term “resource usage” thus can include an absolute technical value when specifying the amount a resource is used; however, the amount a resource is used can also be defined e.g. in ranges, or by more general statements, or can be expressed by values derived indirectly from the component behavior. Accordingly, a resource consumed by a component for processing a task follows a classification on a timescale: Current resource usage which depends on the currently processed: task(s); and/or future resource usage which depends on the task(s) to be processed next. Each component thus can be characterized by its one or more current resource usages and/or by its one or more future/anticipated resource usages.

A method of the present invention provides for operating a resource management system which can directly be implemented in a SoC and provides the control of the distribution of tasks and/or the fashion of the processing of tasks in the respective components of the SoC device. The management of resources allows to simultaneously control different types of resources commonly as described in the predefined scheme.

According to another method of the present invention, the predefined scheme including implemented rules or policies allows to avoid system critical states, such as bottlenecks and system instabilities. As different kinds of resources are regarded, the method of the present invention allows an overall control of the system functionality and thereby ensures that the system's nominal performance is maintained. Especially, the interdependency of the adapting of the task processing of one component for the task processing of another component of the SoC advantageously requires a large set of implemented rules or policies which are described in the predefined scheme.

According to another aspect of the present invention, a data processing system for evaluating and managing the system resources in a SoC environment is provided. The data processing system includes a plurality of components operable to perform dedicated tasks in the data processing system, wherein each of the components having its associated current and/or future-resources' usage(s) depending on the currently processed task and/or on the task(s) to be processed next, respectively. Processing of a task in at least one of the components can be modified such as to adapt the resource usage for this component or another component affected by the modification. For triggering task modification activities the current and/or future resource usage of a set of components is determined/estimated by a resource evaluation unit. A resource management unit is provided to adapt the task processing of at least one of the components according to a predefined scheme, if the current and/or future system state is a critical one.

### BRIEF DESCRIPTION OF THE DRAWINGS

These, and further, aspects, advantages, and features of the invention will be more apparent from the following detailed description of an advantageous embodiment and the appended drawings wherein:

FIG. 1 is an example of a SoC including a number of components, depicted in a data processing view;

FIG. 2 shows one embodiment of the SoC including evaluating and resource managing means according to the present invention;

FIG. 3 shows an aggregation and decision unit as included in the SoC according to the embodiment of FIG. 2;

FIG. 4A shows an embodiment of the aggregation and decision unit according to another embodiment of the present invention;

FIG. 4B shows an organization of an FAD (Future Access Descriptor) generated according to the embodiment of FIG. 4A;

FIG. 4C indicates a forward and backward translation of information of a component;

FIG. 5 shows a data processing system in a SoC environment according to another embodiment of the present invention;

FIG. 6 illustrates a flowchart representing the method for evaluating and managing of system resources according to an advantageous embodiment of the present invention;

FIG. 7 illustrates a SoC according to another embodiment of the present invention; and

FIG. 8 shows an illustration of the data flow in the embodiment of FIG. 7.

### DETAILED DESCRIPTION OF THE INVENTION

The present invention provides methods, apparatus and systems for evaluating and managing system resources in a system-on-chip device and data processing system for evaluating and managing system resources. Thus, the present invention provide a method and a data processing system to control and adjust the diverse system resources in order to support an autonomous fashion of task processing.

According to an example embodiment, a method is provided for evaluating and managing the system resources in a data processing system, particularly in a SoC device. The system has a plurality of components on-chip, each operable to process dedicated tasks in this data processing system. Each of the components uses one or more resources upon execution of an associated task. The term “resource usage” thus defines in this context the type of resource and the amount of resource a component makes use of upon execution of a dedicated task, wherein a component can make use of one or more resources when processing a task. The term “resource usage” thus can include an absolute technical value when specifying the amount a resource is used; however, the amount a resource is used can also be defined e.g. in ranges, or by more general statements, or can be expressed by values derived indirectly from the component behavior. Accordingly, a resource consumed by a component for processing a task follows a classification on a timescale: Current resource usage which depends on the currently processed task(s); and/or future resource usage which depends on the task(s) to be processed next. Each component thus can be characterized by its one or more current resource usages and/or by its one or more future/anticipated resource usages.

The processing of at least one task assigned to a component can be modified to adapt the resource usage of this component or to adapt the resource usage of other components. To optimize the resource usage in at least one of the components, at first one or more resource usages are determined for a set of components, the set e.g. comprising one component, in another embodiment each component, and in yet another embodiment a selection of components, which selection comprises e.g. components known for showing resource usage interaction. This determination/estimation of resource usage/s can comprise the current and/or future resource usage of each component of the set. If the current and/or future resource usage of one of the set's component goes beyond a resource usage limit of the respective component, the task processing of the system is adapted according to a predefined scheme. By way of processing this method in autonomous manner, the operation of the system can be improved.

The present invention also provides a method for operating a resource management system which can directly be implemented in a SoC and provides the control of the distribution of tasks and/or the fashion of the processing of tasks in the respective components of the SoC device. The management of resources allows to simultaneously control different types of resources commonly as described in the predefined scheme.

In some embodiments, the predefined scheme includes implemented rules or policies allows to avoid system critical states, such as bottlenecks and system instabilities. As different kinds of resources are regarded, the method of the present invention allows an overall control of the system functionality and thereby ensures that the system's nominal performance is maintained. Especially, the interdependency of the adapting of the task processing of one component for the task processing of another component of the SoC advantageously requires a large set of implemented rules or policies which are described in the predefined scheme.

For example, resource types such as power, chip temperature, queues, memory buffers, caches, table sizes, bus cycles, processor cycles, coprocessor cycles,,dedicated function components and the like are advantageously considered in common to ensure that the adaptation of the processing of a task in one of the components does not lead to an out of the limits use of the same or another type of resource of another component of the system.

Advantageously, the adapting of the task processing of the system comprises the redirecting of the processing of the task to another component able to process the respective task. Thereby, it is possible to prevent that a task which has to be processed is processed in a component which has currently a high load and is assigned to another component which can perform the same processing as the component the task was associated to. This task can also be redirected to components which are not integrated into the SoC but which are external components which are connected to the SoC via dedicated data ports. For example, the storing of data in an internal memory, e.g. a cache memory, can be blocked by the method of the present invention. Instead the data is directly transmitted to an external memory because the cache memory is full due to a data transmission to or from the cache which is performed simultaneously. Then, the on-chip controller controlling the external memory is the on-chip component which resource usage is determined before task is redirected.

The task processing of at least one of the components can be adapted depending on the current and/or future resource usage and/or on the determined one or more operating states. The task processing can be adapted according to implemented rules or policies previously stored and described in the predefined scheme. Particularly, for components including a receive data queue the operation of the respective component can be adapted depending on the number of tasks to be successively performed, i.e. the number of data to be processed can be adapted.

Furthermore, the operation of the system can be adapted thereby to influence that the likelihood of future resource usage of the respective component can be reduced in the future. Thus, it is possible that, by using the method of the present invention, the likelihood of a deadlock or a system halt due to excessive resource usage, component failure or synchronization problems can be avoided. By transmitting the one or more operating states of each of the components to an aggregation and decision unit all of the information of the estimated current and/or future resource usage can be provided in a single unit thereby facilitating the determining of the managing controls for the concerning components.

Furthermore, while estimating the future resource usage of each component, the likelihood of the estimation is determined. The future resource usage includes the likelihood of a specific resource usage in a further processing of tasks. As it may not be known what tasks are successively processed in one component, it may nevertheless be possible to estimate the future resource usage by knowing the system behavior. Then, this estimation of the likelihood can be useful if the future resource usage cannot be determined precisely because of lack of the needed information.

The resource usages can advantageously be associated to at least one of the group of resource types: power consumption, component temperature, transmission capacity of a data bus, memory space of a buffer, of a cache and/or of a program memory, data queue space and processing capacity.

Advantageously, the task processing of at least one of the components can be adapted by performing a respective task at an earlier or later point of time if this task is able to be postponed or be processed earlier. Or the frequency of one of the components can be altered (e.g. lowered). The above solutions allow to either shift the task processing into the component or into another component and into a time period in which the resource usage level is lower, thereby preventing that the resource usage level reaches its limit.

The estimation of the future resource usage can be performed for succeeding time intervals wherein the resource usage(s) of each or a set of components and of each time interval respectively is determined and a critical time interval is detected if the total use of the managed resource goes beyond the resource usage limit for this particular time interval. Then, the task processing of the component in a critical time interval is adapted to eliminate the critical state of the critical time interval. The length of the time interval can be variable depending on the respective function of the respective component. Thereby, it can be considered that each of the components has its own task processing intervals advantageously, the estimation of the resource usages and/or the predefined scheme to adapt the task processing of the component are learned in an appropriate adaptation strategy.

The present invention also provides a data processing system for evaluating and managing the system resources in a SoC environment. The data processing system includes a plurality of components operable to perform dedicated tasks in the data processing system, wherein each of the components having its associated current and/or future resources, usage(s) depending on the currently processed task and/or on the task(s) to be processed next, respectively. Processing of a task in at least one of the components can be modified such as to adapt the resource usage for this component or another component affected by the modification. For triggering task modification activities the current and/or future resource usage of a set of components is determined/estimated by a resource evaluation unit. A resource management unit is provided to adapt the task processing of at least one of the components according to a predefined scheme, if the current and/or future system state is a critical one.

The data processing system of the present invention provides the resource management unit which controls the task processing in each of the components in the data processing system. The resource management unit includes a predefined scheme according to which the estimated resource usage information of the components is applied to given rules and/or policies. The predefined scheme therefore allows to consider the information on the resource usages of different components and of different types in an integrated fashion. Advantageously, the resource evaluation unit determines resource usages by means of evaluating states of the resource in question. Such states—also called operating states or indicators—advantageously represent measurements with regard to the resource.

Advantageously, the resource management unit—also called aggregation and decision unit—comprises a number of resource management modules associated to the components, respectively. Furthermore, the resource evaluation unit comprises evaluating modules each associated to one of the components. The resource management module and evaluating module of at least one of the components can be included in a common intra-resource evaluation and management module associated (and located proximate) to the respective component wherein any of the intra-resource evaluation and management modules can be interconnected to each other either via a central part of the aggregation and decision unit to provide resource usage data or in a direct fashion. A state evaluation module can be shared by several components of the system on a chip if they are close and similar to each other, e.g., a processor complex.

Thus, it can be provided that each of the resource management modules and each of the resource evaluation modules can be located in a central unit controlling the task processing of each of the components centrally or can be located approximate to the respective associated component(s). If they are placed in a decentralized manner, they have to be interconnected and the predefined scheme has to be implemented in the distributed evaluation and management modules.

It is noted that advantageous embodiments described in connection with the method according to the present invention are also considered as advantageous embodiments of the system according to the present invention, and vice versa.

In FIG. 1, a conventional SoC environment is shown in a data processing view including several components which are interconnected to each other, thereby providing a predefined functionality. Substantially each of the depicted components has a port to exchange data with other system components, indicated by the respective arrows. Without resource control, each of the components is receiving and transmitting requests, data and the like, according to their respective function in an uncontrolled and instantaneous manner.

The SoC environment 1 as shown by example in FIG. 1 comprises an embedded processor 2, internal busses 3, as the processor local bus 3a and the on chip peripheral bus 3b, an SDRAM controller 4, a PCI bridge 5, a number of EMACs 6 (Ethernet Media Access Controller) each interconnected with a dedicated SRAM unit 7 and a memory access layer unit (MAL) 8 to control memory accesses.

The interconnected components shown in FIG. 1 are only an example of possible SoC environments and do not restrict the number and/or the type of possible components used on a SoC environment as used in the present invention.

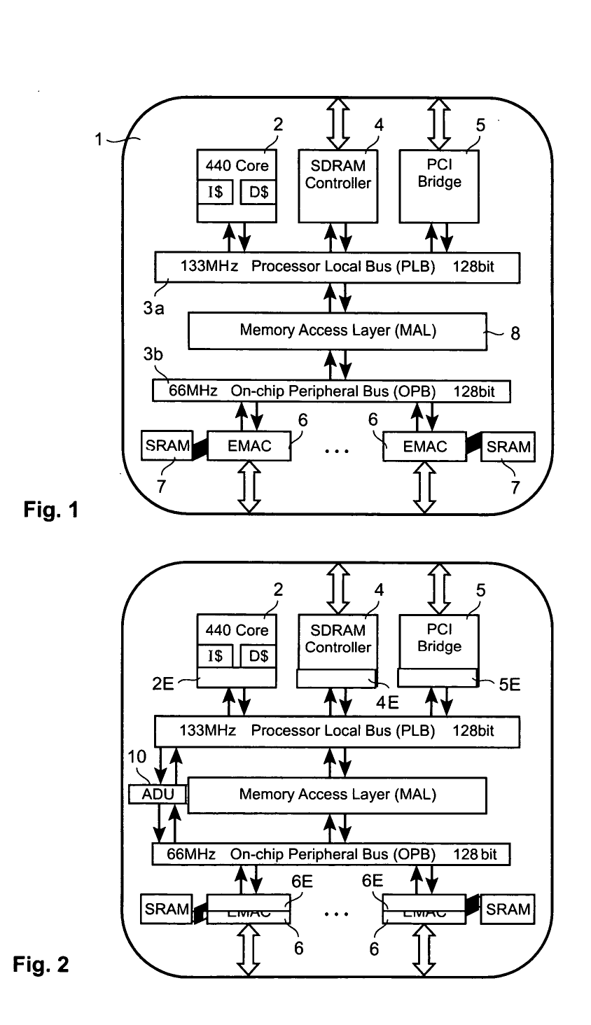

According to an advantageous embodiment of the present invention, in FIG. 2 a data processing system is depicted. The data processing system of FIG. 2 is related to the data processing system as shown in FIG. 1 wherein substantially each of the shown components has its own evaluation unit indicated by the reference supplement “E”. Each of the evaluation units is connected in a direct fashion or via appropriate means with an aggregation and decision unit 10. The evaluation units determine one or more operating states of the respective components and estimate there from the current and/or future resource usage of the respective component depending on the determined operating state(s). The number and the type of resources from which the resource usages are estimated depends on the type of component and on the type of resources which has to be controlled in order to avoid component and system critical states, such as bottlenecks or deadlocks.

The determined information is then transmitted periodically, or in an event-driven manner, for control by the respective functionality of the component to the aggregation and decision unit 10 wherein the information on the resource usage of each of the components is collected, the system state is determined and accordingly decisions for respective actions regarding the control of one or more of the components are generated.

Resources as understood in the present invention can be of various types, e.g. processing capacity, capacity of queue, cache and memory buffers, data transmission capacity of busses and other data interconnections, device and/or component temperature, device and/or component power dissipation etc.

Various other types of resources are conceivable, each limited by the physical design of each component. Resources which are to be regarded by the method of the present invention are of the kind that their usage in the respective component is observable and controllable, i.e. can be influenced by adapting the processing of tasks in the component.

The system according to the present invention allows to manage all of the resources according to a predefined scheme which is implemented by:.rules and policies, as shown hereinafter.

The evaluation of the present and/or future resource usage can be performed in different manners. The resource may be measured as an individual entity (e.g. queue load or processor load) with intra- or inter-resource evaluation. A mechanism performed to establish the load status of a certain resource is defined.

Evaluating is distinguished from monitoring because the load status establishment may be performed by means beyond monitoring. For example, instead of counting the free (or busy) cycles of a processor, one may evaluate the load of a processor by checking either the depth of its input queue or the time between pollings. The main advantage of using evaluation instead of monitoring is that the evaluation is cheaper, less intrusive and of broader scope than monitoring and may be performed in components other than those the resources of which are evaluated. The main disadvantage is that evaluation may be less accurate than monitoring. Considering that the set of evaluation methods is a super-class of monitoring methods, one may select the method for evaluating the resource usage for a component based on the environment, the cost and accuracy requirements.

As only a low number of components allows an accurate monitoring of the resource usage, and thereby an accurate prediction of future resource usage, many components have a set of states which allow at least a rough estimation about the future resource usage, for example, a network interface having a port which contains a buffer. Network data is transferred between the memory and the buffer in larger portions and with higher bandwidth than the network interface transmits data. The resource usage to be evaluated is the currently used bandwidth and the future bandwidth. The future load increase corresponds to the buffer fill level and the bandwidth corresponds to the memory bandwidth. Therefore, the fill level of the buffer and the number of received headers of incoming data frames allow a prediction of when a transfer between a memory and a buffer will be required. Furthermore, the type of data in the buffer allows a prediction about the lengths the requests will have.

An evaluation of a future resource usage is for example also possible when a CPU has many dirty cache lines. A cache miss which includes an allocation of a cache line is very likely to produce a memory write before a memory read is carried out. Hence, the bandwidth between cache and memory is higher when more cache lines are dirty, assuming the cache access pattern is the same. Thereby, it is possible to evaluate the resource usage of the resource. “bus interconnection between cache and memory” of the component “cache” by simply counting the dirty cache lines of a cache memory.

A program executed on a CPU can exhibit a certain fixed behavior. For instance, a program which analyses a stream of images from a camera would periodically read data from a new picture, analyze it and then write the result (e.g. the modified picture or description of the picture etc.) back to the memory. Similarly, in a packet processing software, the program first reads data from the packet, then any reference data and then works with it. At the end of the packet it may be modified, written back and for instance statistics variables may be changed. By either observing the state of the program (e.g. by distinguishing address ranges of memory accesses for packet data reads and writes or by instruction addresses) or by inserting explicit hints into the software, the expected memory operations of a program can be predicted and the future resource usage can be evaluated.

As another example, the instruction cache can be investigated whether it contains the normal, central part of a program which is required most of the time, or some exception code. In the latter case it is more likely that cache misses will occur when the program returns from exception processing to normal processing. Thereby, the likelihood of a future resource usage of the resource “cache memory” can be estimated.

As another example, some peripheral components do periodical transfers to or from the memory, maybe in connection with a DMA (direct memory access). Examples are analogue-to-digital converters (ADC) for sampling audio data. The timer which generates the sampling rate can be observed and thus the time of the access can be predicted very precisely.

Autonomous coprocessors, such as search coprocessors, exhibit a fixed-memory access pattern for searching or looking up or updating the search structure. By observing the requests to the coprocessor (which may be stored in a buffer in the coprocessor) it can be predicted when, how many and which type.(length, direction) of transfers will occur.

Thereby a resource usage of each component can be estimated just by knowing their functionality and an evaluation unit can be implemented to generate an information on the future resource usage of the different kinds of resources.

To influence the further processing of each of the components, that is to perform an adaptation of the task processing of each of the components, the behavior of one or more of the components has to be influenced. In analogy to the examples given above, the following actions can be performed to vary the behavior of the components.

For example, the transfer of the data between the described buffers and the memory can be delayed when there is sufficient or available data in the buffer of the network interface, or the transfers can be split up and partial transfer is started earlier than would otherwise be the case. Although splitting up and transferring data partially can increase the total bandwidth on a data interconnection and can incur higher power consumption of a more frequent change of direction in data transmission, the worst case bandwidth can be lowered whereby the resource usage of the resource “bandwidth of a data interconnection” can be reduced.

Writing back dirty cache lines before the cache line is reused does not change the correctness of the program and Would in fact frequently not even be noticeable by the running program. The likelihood of a write request at a later time is reduced. However, a higher total memory bandwidth can result because a cache line may be modified again after it has been written out to memory. Therefore, the selection of the dirty cache lines to be written back has an influence on the efficiency of this option.

Sometimes programs have several independent tasks to fulfill or several tasks or threads are executed on the same processor. Therefore, the program can be influenced on when the section of the program which requires transfers over said port is executed.

By observing whether parts of the exceptional code in the instruction cache are used over a period of time, the contents of the instruction cache can be exchanged for the typical code beforehand.

The sampling of a unit like an ADC is at a low rate therefore the transfer of data from this unit has only to be carried out before the next value arrives. Given the example of a modern DRAM memory and sampling of audio data, this is a very long time (a typical audio sampling rate is 44 kHz compared to more than 100 MHz for a clock of a DRAM memory).

One option in connection with a coprocessor which requires use of the port is that the selection of requests from the mentioned request buffer is influenced. If there are several types of operations, those operations which make heavier use of the managed port can either be delayed or advantageous in accordance to the current situation. As another option to take advantage of the proposed invention with such a coprocessor might require modification of the coprocessor, in the sense that the coprocessor can start several operations at once and collect the use of the managed port. Thus, if it is desirable to use the port as soon as possible, outstanding uses are started. If, in contrast, the use of the port should be avoided, operations which do not need the port are advantageous.

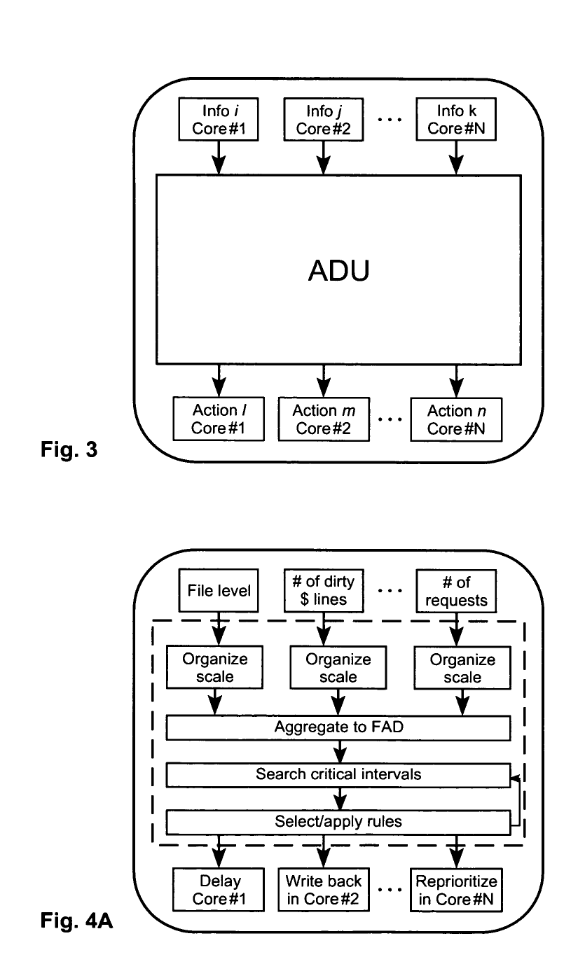

The generated and gathered information on the future resource usage of each of the components is transferred to the aggregation and decision unit, as shown in FIG. 3. From the information collected in the aggregation and decision unit, actions concerning one or more of the components of the SoC are determined and the respective components are controlled in the determined manner. This is depicted in general in FIG. 3.

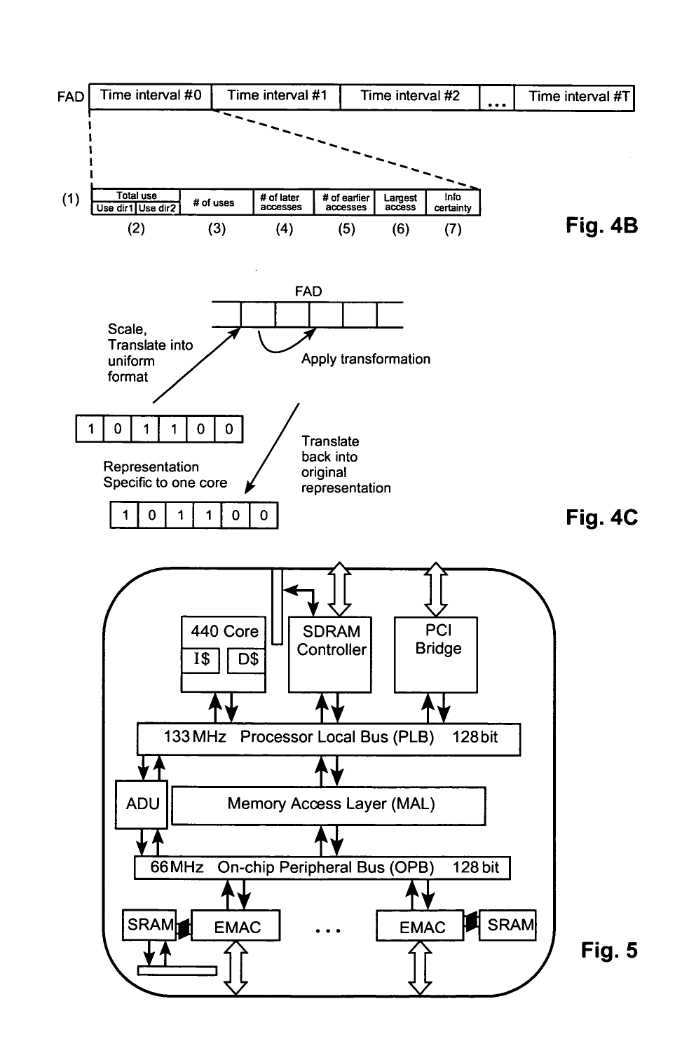

FIG. 4A shows by way of an example a memory cache the operation of which is adapted by the approach according to the present invention. The aggregation and decision unit includes a structure where the use of the resource is described called future access description (FAD). This is the aggregated information on the resource usage. The predictions from the individual components may be in a different format specific for each component, such as a list of accesses and their characteristics, a bit vector where bit positions are related to time which is more applicable if the size of the accesses by this particular component is constant etc. They are also kept because they are needed to carry out the transformation of the FAD.

As shown in FIG. 4B, the FAD can be organized as follows. The time is divided into fixed time intervals. The information from each component is classified into each interval. The intervals have either equal length or increasing length the further out they are. For each interval at least the total use (1) of the managed resource, i.e. the amount of data packets, is collected. Particularly, in case the port has two directions such as memory read and write the amount for each direction is provided (2). Furthermore, the FAD includes: the number of separate uses (3), if a use can have varying lengths such as memory bursts or packets over a RapidIO or Infiniband interface. The largest or longest access/use (again in case of uses of varying lengths); the maximum amount of accesses which can be moved to a later (4) or earlier interval (5), possibly individually accounted by information (2 and 3), i.e. on the amount for each direction and the number of separate uses; the largest access (6) which cannot be moved out of an interval, the certainty of this information (7) and the costs moving of these accesses to another interval.

The FAD information is collected from each of the considered components wherein the information from the different sources has to be scaled in time and volume because the operating frequency, the resulting rate of uses of the managed resource and the individual amount can be different for each component and can vary even for the components in the SoC depending on the configuration, program and etc. Therefore, the scaling factors used may be required to be configurable.

After generating the expected behavior, the aggregation and decision unit searches for critical or non-optimal intervals. A critical interval is one where the total use of the managed resource exceeds its actual or desired maximum capacity. Non-optimum intervals can for instance be intervals with light use where the included data packets may be moved to empty the interval to achieve longer breaks in data transmission, or intervals with an equal amount of accesses in both directions wherein the data packets are sorted into two intervals, one in the first direction and one in the opposite direction, in order to reduce the frequency of changing the transfer direction and thereby to lower the power consumption.

According to the amount of freedom, transformations to the accesses to the FAD are performed in such a way that the critical intervals are eliminated and/or the non-critical intervals are improved. The transformations are recorded. After that, the aggregation and decision unit continues searching for critical or non-optimal intervals until no non-optimal or critical intervals can be removed or improved.

The forward and backward translation of the information for a specific component is illustrated in FIG. 4C. One of the things that have to be enforced is that no endless cycle of transformations results. This can be done either by using a global quality measure and only allowing transformations which improve it, by introducing a sequence on the modified intervals or by using a set of transformations which do not reverse each other. It has to be noted that the optimal selection of the transformation can be complex and therefore finding the total optimum might not be feasible in the given amount of time as usually a decision has to be made in a real-time environment.

If a set of transformations is found, these are sorted per associated components and transferred to the components to control the respective behavior of the component. A possible implementation of this process is by defining the allowed transformations and the conditions of when to apply them by a set of transformation rules. Each rule includes a condition on the characteristics of the considered interval in the FAD and a conclusion of which transformation has to be carried out. Furthermore, weights and priorities can be regarded in the rules.

It has to be noted that some transformations can have consequences on several distinct intervals. For instance, there are cases of a set of transfers which have to be carried out with fixed temporal distances. In this case, changing one of this transactions creates changes in several other intervals in the FAD. This fact is component-specific and is not observable by the FAD alone. Therefore, transformations at the FAD have to be reinterpreted to the representation of the request predictions of the individual components and the impact of the FAD is deduced from that. The rules applied in the aggregation and decision unit have to be in line with this fact and may therefore refer to the representation of the individual components.

The information on the resource usage can either be generated in the component directly as shown in FIG. 2, for instance by counting the dirty cache lines or by finding the longest data frame in the buffer of a network interface. Sometimes the information is generated for other purposes such as debugging, recovering from a crash or needed for a normal operation. If it is not yet present, a modification of the component is necessary. If the data is continuously updated, the effort to do this can be quite low, such as keeping a few counters and a maximum register. The information can then either be stored in a register or memory location in the component or elsewhere, and the aggregation and decision unit fetches the result from there, for instance over the already existing interface or an interface dedicated thereto.

In the case of the program executed in the microprocessor component, new instructions can be added which explicitly transfer the resource usage information. If the resource usage is encoded and reduced to a few typical cases for this program, this can be as simple as adding a single instruction. The insertion of this instruction is either done by a programmer or can be automatically done by a tool based on a formal program analysis or an analysis for profiling results from simulated or actual execution runs.

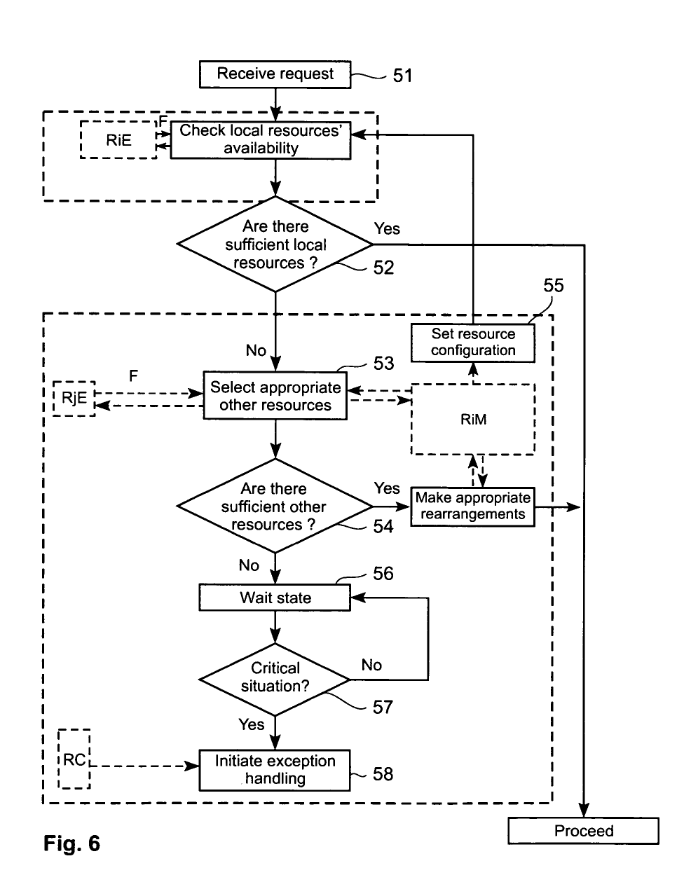

If neither the information is directly available from the component, nor a modification of the component is possible, the information can in many cases also be gained by observing the component behavior from outside, as shown in FIG. 5, for instance a respective evaluation unit can be added which can record the requests submitted to a coprocessor and compare to the results returning from the coprocessor. In this manner, the amount of remaining tasks to be processed in the coprocessor is known. In the same way, if the CPU operates with a cache coherency protocol, the relevant modification to the state of data cache lines is observable from the outside, for instance by the respective evaluation unit. However, determining the number of dirty cache lines would require replicating the cache line tag array which makes it necessary to provide an additional space on the chip environment. As given in the examples above, for some components the existing control options can be sufficient to achieve the required control of the component. For instance, components can have an option for stopping its operation completely in order to save power. If a coprocessor is known to have sufficient time for its remaining tasks to be processed, it can be temporality stopped in a critical interval where e.g. the total power consumption of the SoC exceeds a power consumption limit or another limited resource has to be considered. Another example is using registers which are intended for one initial configuration to adapt the behavior of the associated component, e.g. buffer-fill level thresholds of a buffer.

In the case of the CPU cache, the cache coherency protocol can be used to force write-out of dirty cache lines. If this is not sufficient, a modification of the cache controller can be required.

Furthermore, a filter may be added to the interfaces of the components which modifies the input data. An example is the reordering of requests to a coprocessor. In some cases, the modification can be done to another component by the program executed on a CPU. If this other component produces the inputs, it is possible that the timing to receive results from a component indirectly affects the behavior of the component.

The determination of the required actions is performed in the aggregation and decision unit. Therefore, a predefined scheme is implemented in the aggregation and decision unit which can be predetermined by a programmer or a designer of the SoC environment or can be implemented by different well-known adaptation methods.

In a dynamic environment, it may be impractical or impossible to manually determine or predetermine a correct configuration: that is a set of rules, scaling factors and selection of indicators of concerned components. An adaptation method is therefore useful. The aggregation and decision unit continuously or in intervals observes the indicators which may be given by the resource usages, and the behavior of the components. On the basis of this observation, it adjusts its configuration, i.e. the predefined scheme is adjusted by modifying or generating rules. Both the prediction and the actions can be learned. For the predictions, the observed indicators from the respective component and its later processing behavior are put in relation and future behavior is determined. For the action, the aggregation and decision unit can apply the control signals in different fashions after observing a comparable indicator value and observe how the behavior is influenced by this. It is noted that although the behavior of a component (particularly a CPU executing a software program) can change dynamically the rough picture on how to interpret an indicator or in which direction a certain action influences the access pattern is clearly known.

Learning can be done in a real system or in a simulator when designing the system. In a complex system, the necessary set of rules to determine the resulting action cannot be established by a program. One option is to use a genetic algorithm together with a simulation module of the target system. As it is typically not very difficult to write down individual parameterizable rules finding a proper combination of these rules is complex, so that it might be helpful to use intelligent expert systems to establish the rules. For tasks such as these genetic algorithms have been successful. Another option is using a former model and deriving a rule set by a symbolic transformation program such as a theorem proved or linear optimization tool. A neural network can as well be used to achieve a working set of rules.

In the method of the present invention, the evaluation of resource usage is performed per system resource (both on and off chip) and can be resource-specific. In one more specific embodiment, the system resources evaluated can be application, data path-related. Thus, resources to be evaluated are ingress and egress queues, component input and output queues, buffers, table sizes, bus, processor (cycles, instructions and data cache availability, possibly per thread) and dedicated function components utilization and the like.

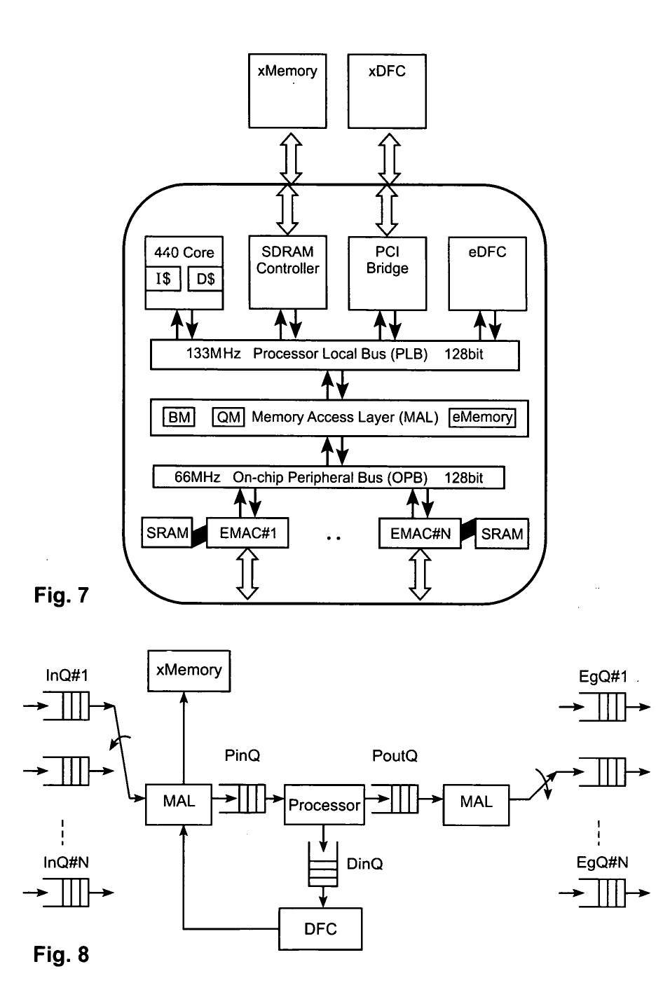

By having the resources of a system application data path mapped, as shown in the exemplary system of FIG. 7 one may relate them as part of a data path. This mapping includes the information on how the utilizations of different resources are linked, this is how the usage of one component's resource influences the utilization for another component's resource. Thus, in this application, resource mapping enables us to make effective resource tradeoffs and inter-resource management decisions in a distributed fashion. While this application data path specific resource partitioning increases the complexity and introduces overhead in the system, it is considered to be essential in order to evaluate and manage the resource usages of the system in a most effective way. It is the intention and a requirement to keep the complexity and overhead of the resource evaluation and managing framework to a minimum.

It can be provided that while the resource evaluation is resource-specific, the outcome of any resource evaluation is organized and scaled, as illustrated in FIG. 4A, in order to take the same format, say FAD, for all components. Every evaluated component has n bits (n=1) Flag-value, say F, where F corresponds to part (1) of the FAD structure, that indicates the load of the resource of the component. The range of the values of F represents a scale of the component load, wherein, for instance, n=1 F=0 stands for not loaded while F=1 for loaded or for n=2, F=00 stands for low utilization while F=11 stands for very high utilization. Both n and the interpretation of the values of F are established during design or configuration of the system on chip environment. Having a coarse indication of resource utilization enables the system to converge and eliminates frequent changes in the system that may cause instability. The smaller the size of the less the changes but the coarser the control. The mapping between resource utilization and F can be different per component and depends on the component, its environment and the allowable cost. In addition, it is not necessary that all components use the full range of F, since some components may never indicate certain states, like “very high loaded” because they have abundant resources.

The inter-resource management function can have a central module and a number of distributed modules. The central module (or ADU) is responsible for configuring and managing the distributed resource management units and providing global resource control as it will be described later. The distributed resource management modules are located in the associated components of the system such as the processor, the memory management unit, the ports and the like. Their main responsibility in cases of need is to check the resource availability (or usage) of appropriate components and, if possible, carry out the necessary rearrangements (reconfiguration). Similarly to the resource evaluation modules, the resource management modules are not necessarily located close to the components whose resources are managed. For example, the resource management module of a queue may be located in the queue manager and not in the memory (controller) where the actual queue is located.

The activation of a resource management action can be initiated by two causes. The first is resource request driven, i.e. application driven, and is handled by a local resource management module. This case is the most frequent one and appears when resource requests from a packet, stream and/or component cannot be immediately satisfied due to temporal overload of the resource. A method for this resource management is shown in FIG. 6, wherein the resource evaluation and management are depicted in a flow chart. If a request is received (step S1), the availability of local resources is determined and it is checked (in Step S2) whether there are locally available requested resources. This is checked by interrogating the associated resource evaluation module. If requested resources are available, normal processing continues. If there are not enough resources, requested available other resources are selected (Step S3). The configuration has to be adjusted by the other appropriate resources found (Step S5). In a next step S4 it has to be checked if there are sufficient other appropriate resources available. If no sufficient other appropriate resources are available go to a waiting state (step S6). If there are other possible resources available, adjust configuration and proceed with normal operation. After the waiting state, it is assessed if a critical situation has occurred (step 7). If a critical situation has occurred, initiate an exception handling routine (step S8), otherwise go back and check whether resources are now available.

The new resource configuration lasts only as long as the problem, or the resource request exists; this is also configurable. Immediately after, the component's resources return to their initial, normal operation configuration. The waiting state is equivalent to the state of the resource/component, as if the resource evaluation and management scheme did not exist. The idea is to prevent processing of the task in the component in a waiting state. If this is not possible, the next contribution is to guard the waiting state. Thus, if the situation persists and the state of the resource may jeopardize the state of the overall system, then the resource evaluation and management scheme introduces an exception handling.

Exception handling can be component-, application- and resource-specific and constitutes special drastic measures necessary to bring the system into a stable and safe state. Some examples include packet dropping, port closing, service level agreement (SLA) rearrangement, temporal priority readjustment and the like. Typically, exception handling may be accommodated with an appropriate message to the control and management unit of the higher-level system.

The above-described method is an extended one. Various less complicated methods can be derived from the above, for example there can be only one other resource option or no exception handling and or there can be no test for critical situation and so forth.

The second cause of resource management activation is control-driven. This case is activated only during certain system states that may cause severe problems and therefore is more global. A resource control unit may either collect error messages or exception handling events or other specialized events or messages from the system components/resources and evaluate them based on certain preconfigured mechanisms. When certain conditions are met then the resource control unit initiate a number of actions (e.g. exception handling) on different system components/resources.

The resource management module can be centralized in its entirety and then any resource status can be communicated (aggregated) from the respective component to the resource management module which then polls the status (or appropriate resource usages) of the appropriate other resources, decides on new resource configurations and communicates these decisions to the necessary components to invoke associated actions by modifying the processing of tasks. However, this approach increases the communication overhead the response time and the complexity of the central component.

The resource evaluation components can be used for other purposes such as for intra-component management or resource scheduling. Similarly, the inter-resource management scheme can be used without the resource evaluation, i.e. it can be used for example in an empirical fashion.

FIG. 7 shows another example embodiment of the present invention considering a system on a chip network processor architecture. The network processor system comprises a number of EMACs, a memory access layer (MAL), an embedded processor, embedded dedicated function components eDFC, an SDRAM controller, a PCI bridge and two interconnect structures. The memory controller handles transfers to and from an external memory (xMemory) and the bridge interfaces with an external dedicated function component xDFC. The MAL has a buffer manager BM and a queue manager QM unit.

In this example embodiment we consider that any data communication between the components of the system is performed via queues (see FIG. 8). Thus, upon arrival the packet is enqueued in an ingress queue (InQ#i), which is located in EMAC#i, i=1, . . . , N. When the packet reaches the front of the ingress queue the MAL (BM) allocates a buffer for its storage (xMemory) and the queue manager creates a queue entry in the input queue of the processor, say PinQ. If the packet requests special treatment then the processor sends it to the input queue (eDinQ or xDinQ) of the respective dedicated function component DFC; in the case of a xDFC the queue is actually for the bridge. When the DFC finishes execution, it enqueues the packet back to the input queue PinQ with the help of the queue manager QM. The processor finishes processing the packet and then enqueues it to the output queue PoutQ. The queue manager QM then enqueues the packet to the appropriate egress queue EgQ#j of EMAC#j.

Let as assume that the queues of the system (except the port queues) are located in embedded memory (eMemory) in the MAL. So are the pointers to the queues and the packet buffers. The entries to the queues need not be the whole packets. They can be predefined data structures with well defined packet information.

Considering the following scenario, and assuming that a packet arrives to the processor and needs to be header compressed before it is transmitted, the processor though is overloaded and doesn't have the necessary resources to header compress the packet. The packet (queue entry) then will remain in a (most probably software) queue until the processor has the available resources, which in effect will increase the latency of the packet and thus reduce the performance of the system.

Considering also that there might be a whole burst of packets with the same requirements the overall performance of the system may be temporally degraded significantly. One solution could be to introduce an external header compression coprocessor (xDFC) and thus offload the processor. However a bursty traffic may cause high traffic between the network processor, the external memory and the external dedicated function component which may increase the power consumption of the system and still not solve the temporal latency and performance degradation issues.

Another solution could be the following. Assuming that the output link to where the packet is to be send has light load the header compression can be only partially or not at all needed. Thus, for example, the packet can be send as is, offloading the processor (or the inter-chip communication) and increasing the load of the link, but to an acceptable level. In order such a scenario to be possible the load of the components of the system has to be first known and second communicated to the other components. Moreover, a strategy on how to temporally reallocate resources in the system should be established according to the present invention.

Resource evaluation is performed for each component and can be component-specific, i.e.that the evaluated resources can be of different types. What is required is that the outcome of a resource evaluation of any component is of a common format, here FAD with an n-bit flag-value, indicating the load of the resource. Here a 2-bit flag-value is considered. An example can be the following:

| | |
|---|---|
| 00 | low utilization/load |
| 01 | medium utilization/load |
| 10 | high utilization/load |
| 11 | error- an error or abnormal operation has occurred. |

Some examples of how a resource can be evaluated are describes as follows: Assuming that the system has an active queue management (AQM) algorithm which is based on the queue fill-levels of the egress ports and which decides whether to drop or forward the packets in the egress port queues. Such an algorithm uses certain thresholds to estimate the queue fill-levels. One can use directly the output of the AQM function to evaluate the load of the output ports and use this information to notify the rest of the system components. That is, write the status of the egress queue, i.e. “00” below threshold 1, “01” between thresholds 1 and 2 and “10” above threshold 2- in a 2-bit (part of a) register Fi. A value “11” may indicate queue spill. The update of Fi, where i is the components number, is performed only when the status of the egress queue changes. The actual evaluation is part of the AQM function. This evaluation case introduces minimum system overhead.

The load evaluation of other system queues, where AQM is not present, can be performed in different ways. Metrics used may include the number of-queue entries as compared to some thresholds, or-the rate with which the queue fills, or the number of queue entries at certain events (e.g. processor polling), and so forth. The cost varies from method to method, but typically it includes a counter or two, a register for the sum and a (part of a) register for the flag value. If thresholds are involved then more registers and some basic comparators (min/max) are needed. It is also possible that timers may be used. Similar procedures can be used for the evaluation of the buffer space utilization, where the number of queue entries may be replaced by the number of buffer pointers (or IDs).

It is also possible to use already existing or introduce new events. Then certain events may indicate certain loads, such as when event 1 then “00”, or when event 1 then if “00” then “01” otherwise “00”. Such events may be, for example, created by the bridge when the XDFC doesn't respond or creates an error. Considering though that events may create interrupts in the system any additional events may not be desirable. Already existing events that may be used can be for example processor polling the time duration between consecutive polling events may indicate the load of the processor-, or components' non-acknowledge responses, or certain snooping results, and the like. For example, for memory bandwidth evaluation, the number of times the memory controller was arbitrated in a certain perixod (arbitration frequency) may be used.

As already explained the resource evaluation is resource dependent and performed in a distributed fashion. That is, either at the different resource locations (e.g. ports) or at components that have the necessary information (e.g. queue manager QM and buffer manager BM). It is also considered that certain components may be enhanced in functionality to support such evaluations (e.g. bus arbiter). The only information available to all (necessary) components is the flag-values FAD per resource i. Considering that per resource we need only the flag-value Fi which has only 2 bits, in a 32 bits register one can map up to 16 resource statuses, if the register is dedicated to certain components.

The status can be directly written by the components to the registers, or since it is only 2 bits, one may consider adding it to an existing data structure as it traverses the system. For example a component may write its status into a queue entry, which then will be used by another component to update its flag values. Or an egress component (e.g. port) upon releasing a buffer may add this information in the freed buffer descriptor. The insertion of status information into already existing data structures reduces the communication overhead.

The resource management unit has a central and a number of distributed modules. The distributed resource management modules (RiM) are located in appropriate resources of the system, such as the processor, the MAL, the ports and the like.

For better illustration of the resource management function, the header compression example is now picked up. When the packet arrives to the processor, the processor identifies the packet as one that needs header compression and then checks its associated resources flag-value Fi (e.g. instruction and data cache size, and processor cycles for the specific thread). If its resources are not sufficient it checks the flag-value Fj of the established transmit port of EMAC#j of the packet. This is performed by reading the appropriate register (location). If the status (flag-value) of the port is “00” then the processor enqueues the packet as is. If it is “01” it performs partial header compression (e.g. either UDP/IP or IP header or not at all instead of RTP/UDP/IP), depending on its own available resources. If the status is “10” it keeps the-packet until enough resources are available to fully compress the packet and then transmit it (wait state). An extension could also be, if the port is in “11” status, that is overspilled, then drop the packet (exception handling). The processor may remain in the wait state until either its resources are freed or its input queue is full which leads to an exception handling (e.g. drop packets, or change thread priorities, or some other action).

The present invention provides a novel scheme for evaluating and managing resources in a SoC environment. However, the present invention is not restricted to the given examples in the foregoing specification concerning network processor hardware architecture and system and can be applied to any hardware or software application-specific architecture and system. Such include, but are not limited, to any communication, media, automotive and other systems. Moreover, while the present invention focuses on SoC environments, similar approaches can be used in embedded or multi-chip architecture which are also within the scope of the present invention number

Furthermore not only the use of a port but other aspects of system like power consumption and heat dissipation, noise generation, mechanical stress in a micro-system consisting of electronics and micro-mechanics or system reliability can be applied. For instance it could be avoided that in a redundant system two components do risky actions at the same time. The data structures, aggregation method, diagnosis interfaces and methods as well as reaction options may be similar.

Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which when loaded in a computer system is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. A method comprising an on-chip data processing system comprising evaluating and managing system resources of the on-chip data processing system, wherein the system having a plurality of components each operable to process dedicated tasks, wherein each of the components having associated one or more current resource usages depending on the currently processed task and/or having associated one or more future resource usages depending on the task to be processed next, wherein a resource usage indicates the type of resource and the amount of the resource used,
wherein the processing of at least one task can be modified to adapt a resource usage of the component such task is assigned to or of other component;
the step of evaluating and managing including following steps:
determining the current and/or future resource usage for at least a set of components;
if the current and/or future resource usage of at least one component of this set goes beyond a given resource usage limit of the respective component, adapting the task processing of the system according to a predefined scheme.

2. A method according to claim 1, wherein the step of adapting the task processing of the system comprises a redirecting of the processing of a task assigned to one component to another component.

3. A method according to claim 1, wherein the task processing assigned to at least one of the components is adapted depending on the current and/or future resource usage determined for this or another component.

4. A method according to claim 1, wherein the task processing of at least one of the components is adapted according to implemented rules or policies previously stored.

5. A method according to claim 1, wherein the adapting of the task processing is performed depending on the number of tasks to be successively performed.

6. A method according to claim 1, wherein the adapting of the task processing is performed to influence the likelihood of a reducing of a future resource usage of the respective component.

7. A method according to claim 1, including the following step:
transmitting information related to one or more operating states of components to a resource management unit.

8. A method according to claim 1, wherein while estimating of the future resource usage of the components a likelihood of the correctness of the estimation is determined, and
wherein the estimated future resource usage includes the likelihood of resource usage in a further processing of tasks.

9. A method according to claim 1, wherein the components are interconnected via respective ports wherein the resource usage is defined by the data traffic of each port.

10. A method according to claim 1, wherein at least one of the resource usages is based on one of the following resource types: power consumption, component temperature, transmission capacity of a data bus, memory space of a buffer, of a cache and/or of program memory, data queue space and processing capacity.

11. A method according to claim 1, wherein at least one of the components is a cache memory, wherein the bandwidth of a data transfer to and from the cache memory is depending on the cache misses wherein the cache strategy is adapted depending on the rate of cache misses.

12. A method according to claim 1, wherein the adapting of the task processing of at least one of the components comprises a performing of a respective task at an earlier or a later time.

13. A method according to claim 12, wherein an estimating of future resource usages is implemented by estimating the resource usages for a set of components and for each time interval within a set of subsequent time intervals respectively, wherein a time interval within this set of time intervals is detected as a critical time interval when the resource usage estimated for this time interval goes beyond the resource usage limit, and wherein for a component's critical time interval the assigned task processing is adapted.

14. A method according to claim 13, wherein the length of the time interval is variable depending on the respective function of the respective component.

15. A method according to claim 1, wherein the estimating of the resource usages and/or the predefined scheme to adapt the task processing of the component are learned by an appropriate adaptation strategy.

16 A data processing system for evaluating and managing system resources of an on-chip system, including:
a plurality of on-chip components operable to perform dedicated tasks, each of the components having associated one or more current resource usages depending on the currently processed task and/or having associated one or more future resource usages depending on the task to be processed next, wherein the processing of a task of at least one of the components can be modified such to adapt the resource usage of this or other component;
a resource evaluation unit for determining the current and/or the future resource usage for at least a set of components;
a resource management unit for adapting the task processing of at least one of the components according to a predefined scheme, if the current and/or future resource usage of one component of this set goes beyond a given resource usage limit.

17. A system according to claim 16, wherein the resource management unit comprises a number of resource management modules associated to the components, respectively.

18. A system according to claim 17, wherein the resource evaluation unit comprises evaluating modules each associated to one of the components.

19. A system according to claim 18, wherein the resource management module and state evaluating module of at least one of the components are included in a common intra-resource evaluation and management module associated to the respective component, wherein any of the intra-resource evaluation and management modules is either interconnected to a central part of the aggregation and decision unit to provide resource usage data or proximate to the respective component.

20. An article of manufacture comprising a computer usable medium having computer readable program code means embodied therein for causing functions of an on-chip data processing system, the computer readable program code means in said article of manufacture comprising computer readable program code means for causing a computer to effect the steps of claim 1.

21. A program storage device readable by machine, tangibly embodying a program of instructions executable by the machine to perform method steps for an on-chip data processing system, said method steps comprising the steps of claim 1.

22. A computer program product comprising a computer usable medium having computer readable program code means embodied therein for causing functions of an on-chip data processing system, the computer readable program code means in said computer program product comprising computer readable program code means for causing a computer to effect the functions of claim 11.
